(19) United States
(12) Patent Application Publication
(10) Pub. No.: US 2026/0228095 A1
(43) Pub. Date: Aug. 6, 2026

(54) METHOD AND SYSTEM FOR FAULT TOLERANT REROUTING FOR MASSIVELY PARALLEL PROCESSING ARRAY

(71) Applicant: Cornami, Inc., Dallas, TX (US)

(72) Inventor: Martin Alan Franz, II, Dallas, TX (US)

(21) Appl. No.: 19/046,222

(22) Filed: Feb. 5, 2025

(51) Int. Cl. G06F 11/20

(52) U.S. Cl. CPC G06F 11/2028; G06F 11/2041

(57) ABSTRACT

A system and method to replace a defective tile of an array of tiles on a die is disclosed. Each tile in includes a plurality of processing cores. Each of the tiles are in communication with each other through a network. A defective tile is detected and a spare tile external to the tiles is selected. Packets sent on the network to the defective tile are directed to the spare tile. The function of the defective tile is assigned to the spare tile.

### TECHNICAL FIELD

The present disclosure relates generally to multi-core systems relying on interconnections between tiles of cores to provide programmable architectures. More particularly, aspects of this disclosure relate to techniques to route connections for tiles of cores on an array to a spare tile to replace tiles that have manufacturing defects, while maintaining functioning of the chip.

### BACKGROUND

Computing systems are increasing based on homogeneous cores that may be configured for different executing applications. Thus, such cores may be adapted for many different operations and be purposed for various parallel programming tasks. The cores are typically fabricated on a die. Such dies may be fabricated so they may be divided to allocate the needed processing power. The processing performed by such dies thus relies on many cores being employed to divide programming operations. One example of such division may be a streaming model of programming multiple cores that employs different threads that are assigned to different cores.

Such dies therefore have an array of cores that may be selectively employed for different operations such as for massively parallel processing. Groups of the cores are selected for such different operations. Efficient layout selects cores in as close as proximity as possible for the execution of the operations. One problem with dies with massive numbers of cores, is the possibility of defects from fabrication or manufacture. For example, a Massively Parallel Processing Array (MPPA) containing 8192 cores may suffer from manufacturing or environmental defects causing they array to have a less than 100% yield on usable cores. When configuring the cores for different applications, cores with defects cannot be incorporated into the applications.

During the manufacturing process of wafers, defects are possible in any area of the wafer. In relation to manufacturing efficiency, the greater non-defective parts from a wafer available, the lower the cost per die from that wafer. For example, an architecture with an array of cores organized into tiles may be fabricated on a wafer. One such architecture is the Tigris chip from Cornami that has an array of processing cores organized in tiles. The chip thus has an 8×16 array of tiles for a total of 128 tiles and 2048 cores. In this example, the tiles represent approximately 48% of the die area. Thus, it is a challenge work around address defects that occur on tiles in the die area to prevent discarding an entire wafer or die.

Thus, there is a need for a method to work around defective tiles in a wafter to produce more good dies per wafer and lower the cost per die. Thus, there is a need for a technique for readily allowing application functionality on an array of cores architecture that may use extra cores.

### SUMMARY

One disclosed example is a method to replace a defective tile of a plurality of tiles. Each tile in the plurality of tiles includes a plurality of processing cores. Each of the tiles are in communication with each other through a network. A defective tile of the plurality of tiles is determined. A spare tile external to the plurality of tiles is selected. Packets sent on the network to the defective tile are directed to the spare tile. A function of the defective tile is assigned to the spare tile.

A further implementation of the example method is where each of the tiles includes a memory input/output processor (MIOP) that routes packets to other tiles. Another implementation is where packets to the defective tile are rerouted by the MIOP providing an address of the spare tile to the packets. Another implementation is where each of the tiles includes a tile network coupled to each of the plurality of processing cores in each tile. Another implementation is where each of the processing cores in each of the tiles includes local interconnections to each neighboring processing core and a long wire interconnection to the MIOP. Another implementation is where the defective tile includes a defective processing core determined via a testing routine conducted by a host processor. Another implementation is where each of the processing cores in each of the tiles are homogeneous. Another implementation is where the plurality of tiles are arranged in an array fabricated on a die. The spare tile is fabricated on the die in proximity to the array. Another implementation is where a packet generated by the spare tile is routed through the network to the defective tile. Another implementation is where at least a subset of the plurality of tiles including the defective tile is configured to perform a computational function.

Another disclosed example is a computer system that includes a plurality of tiles. Each of the tiles include a plurality of processing cores and an interconnection. A network is coupled to the interconnections of each of the plurality of tiles to allow communication between the plurality of tiles. A spare tile includes a plurality of processing cores and an interconnection coupled to the network. The spare tile is located external to the plurality of tiles. The spare tile is selected when a defective tile of the plurality of tiles is determined. Packets sent on the network to the defective tile are directed to the spare tile. A function of the defective tile is assigned to the spare tile.

A further implementation of the example computer system is where each of the tiles includes a memory input/output processor (MIOP) that routes packets to other tiles. Another implementation is where packets to the defective tile are rerouted by the MIOP providing an address of the spare tile to the packets. Another implementation is where each of the tiles includes a tile network coupled to each of the plurality of processing cores in each tile. Another implementation is where each of the processing cores in each of the tiles includes local interconnections to each neighboring processing core and a long wire interconnection to the MIOP. Another implementation is where the defective tile includes a defective processing core determined via a testing routine conducted by a host processor. Another implementation is where each of the processing cores in each of the tiles are homogeneous. Another implementation is where the plurality of tiles are arranged in an array fabricated on a die. The spare tile is fabricated on the die in proximity to the array. Another implementation is where a packet generated by the spare tile is routed through the network to the defective tile. Another implementation is where at least a subset of the plurality of tiles including the defective tile is configured to perform a computational function.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1A is a diagram of a chip having four dies each having multiple processing cores;

FIG. 1B is a simplified diagram of one of the dies on the chip shown in FIG. 1A;

FIG. 2A is a block diagram of the array of cores in the die in FIG. 1B;

FIG. 2B is a three-dimensional view of the array of cores in the die in FIG. 1B;

FIG. 3 is a three-dimensional view of the array of cores that is suitable for selection for implementation of different operations;

FIG. 4 is a footprint of a chip having one of the dies with an array of tiles composed of the cores in FIG. 1A;

FIG. 5 is a diagram of using an example replacement tile for a defective tile in the array of cores in the chip in FIG. 4;

FIG. 6 is a diagram of an example bad tile that reroutes communications to an extra tile; and

FIG. 7 is a table of addresses for a defective tile when a replacement tile is used.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward a method and system that includes spare tiles outside of an array of tiles defined on a wafer. Each tile has a series of processing cores that are interconnected by a local network. A network connects each of the tiles and thus allows communication of data packets between each tile. The processing cores on a group of tiles may be configured for different functions and operations.

The spare tiles are connected to memory input/output processors (MIOP) that are part of the network connecting the processing cores in the tile. For example, 4 spare tiles for a main array of 128 tiles may be supplied. A MIOP in each of the tiles in the main array may wrap different data signals in and out of the spare tiles. If a tile is defective but the chip network is functional, the example routine enables routing signals from an intercept location of the defective tile to a replacement tile. In this manner, the configuration of tiles may still operate on the array despite a defective tile as spare tile may take the place of the defective tile.

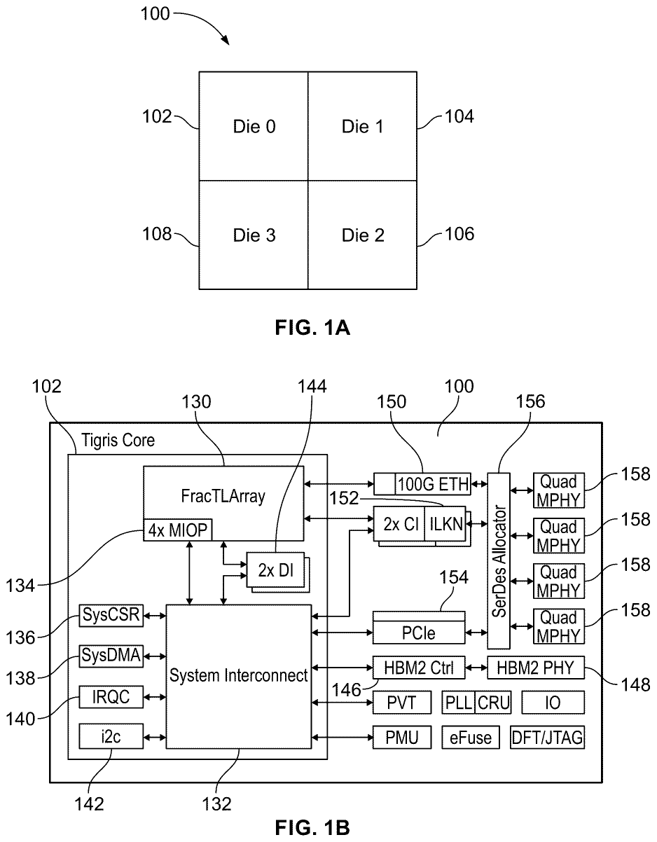

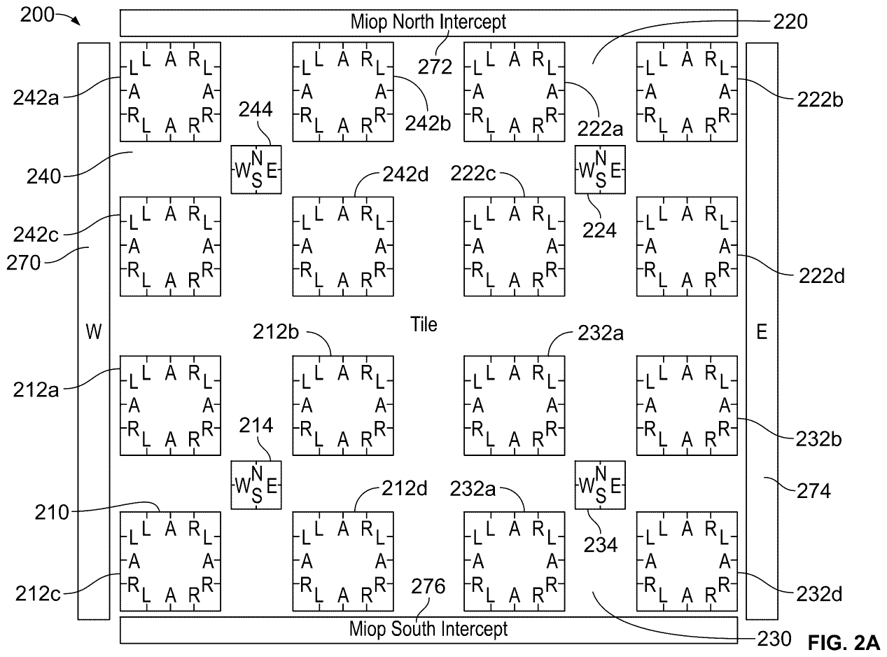

FIG. 1A shows an example chip 100 that is subdivided into four identical dies 102, 104, 106, and 108. Each of the dies 102, 104, 106, and 108 include multiple processor cores, support circuits, serial interconnections and serial data control subsystems and may each constitute a computer system or be part of a computer system. For example, the dies 102, 104, 106, and 108 may each have 2,048 processing cores as well as SERDES interconnection lanes to support different communication protocols. There are die to die parallel connections between the dies 102, 104, 106 and 108. Thus, each of the dies 102, 104, 106, and 108 in this example are interconnected by Interlaken connections. The chip 100 is designed to allow one, two or all four of the dies 102, 104, 106, and 108 to be used as a computer system. The pins on a package related to un-used dies are left unconnected in the package or the board. The dies are scalable as additional chips identical to the chip 100 may be implemented in a device or a circuit board. In this example, a single communication port such as an Ethernet port is provided for the chip 100. Of course, other ports may be provided, such as one or more ports for each die.

FIG. 1B is a block diagram of one example of the die 102. The die 102 includes a fractal array 130 of homogeneous processing cores. The processing cores in the fractal array 130 are interconnected with each other via a system interconnect 132 that serves as a network for communication between the processing cores. The entire array of cores 130 serves as the major processing engine of the die 102 and the chip 100. In this example, there are 2048 cores in the fractal array 130 that are organized in a grid.

The system interconnection 132 is coupled to a series of memory input/output processors (MIOP) 134. The system interconnection 132 is coupled to a control status register (CSR) 136, a direct memory access (DMA) 138, an interrupt controller (IRQC) 140, an I2C bus controller 142, and two die to die interconnections 144. The two die to die interconnections 144 allow communication between the array of processing cores 130 of the die 102 and the two neighboring dies 104 and 108 in FIG. 1A.

The chip includes a high bandwidth memory controller 146 coupled to a high bandwidth memory 148 that constitute an external memory sub-system. The chip also includes an Ethernet controller system 150, an Interlaken controller system 152, and a PCIe controller system 154 for external communications. In this example each of the controller systems 150, 152, and 154 have a media access controller, a physical coding sublayer (PCS) and an input for data to and from the cores. Each controller of the respective communication protocol systems 150, 152, and 154 interfaces with the cores to provide data in the respective communication protocol. In this example, the Interlaken controller system 152 has two Interlaken controllers and respective channels. A serializer/deserializer (SERDES) allocator 156 allows allocation of SERDES lines through quad M-PHY units 158 to the communication systems 150, 152 and 154. Each of the controllers of the communication systems 150, 152, and 154 may access the high bandwidth memory 148.

In this example, the array 130 of directly interconnected cores are organized in tiles with 16 cores in each tile. The array 130 functions as a memory network on chip by having a high-bandwidth interconnect for routing data streams and data packets between the cores and the external DRAM through memory input/output processors (MIOP) routers 134 and the high bandwidth memory controller 146. The array 130 functions as a link network on chip interconnection for supporting communication between distant cores including chip-to-chip communication through an “Array of Chips” Bridge module. The array 130 has an error reporter function that captures and filters fatal error messages from all components of array 130.

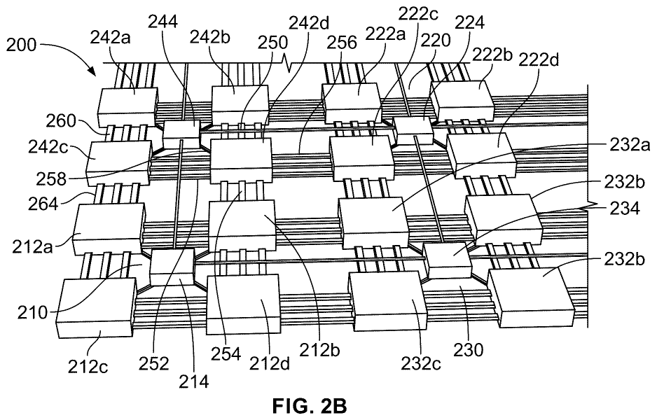

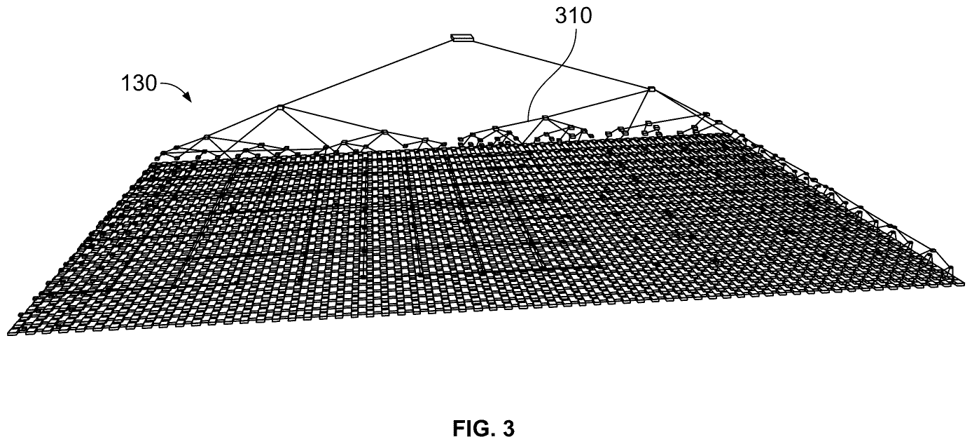

FIG. 2A is a detailed diagram of a tile 200 that is composed of sixteen cores of the array of cores 130 in FIG. 1B. FIG. 2B is a three-dimensional image of the tile 200. The example tile 200 is organized into four core clusters such as the clusters 210, 220, 230, and 240 shown in FIG. 2A. For example, the cluster 210 includes cores 212a, 212b, 212c, and 212d. Each of the four cores in each cluster 210 such as cores 212a, 212b, 212c, and 212d are coupled together by a MIOP router 214. FIG. 2B shows other clusters 220, 230, and 240 with corresponding cores 222a-222d, 232a-232d and 242a-242d and corresponding MIOP routers 224, 234, and 244.

As may be seen specifically in FIG. 2B, in this example, each of the processing cores such as the processing cores 242a, 242b, 242c, and 242d in the cluster 240 has up to four sets of three interconnections [L, A, R]. For example, a core in the center of the tile 200 such as the core 242d includes four sets of L, A, R, interconnections 250, 252, 254, and 256 each connected to one of four neighboring cores. Thus, core 242b is connected to the core 242d via the interconnections 250, core 242c is connected to the core 202d via the interconnections 252, core 212b is connected to the core 242d via the interconnections 254, and core 222c is connected to the core 242d via the interconnection 256. A separate long wire interconnection 258 is coupled to the wire MIOP router 244 of the cluster 240. Thus, each core in the middle of the array has four sets of interconnections, while border cores such as the core 242c only have three sets of interconnections 260, 252, and 264 that are connected to respective cores 242a, 242d, and 212a. In this example, there are sixteen cores that constitute a tile. The respective L, A, R interconnections form a tile network within the processing cores of the tile.

The tile shown in FIG. 2A also includes interconnections 270, 272, 274, and 276 on four sides termed, W, N, E, and S. In this example each of the interconnections 270, 272, 274, and 276 allow inter tile communication via the respective MIOPs routers 214, 224, 234, and 244 through each of the cores near the interconnection. For example, the interconnection 270 is connected to the L, A, R interconnections from the cores 242a, 242c, 212a, and 212c and the wire interconnections to the MIOP routers 244 and 214. In this example, the interconnections 270, 272, 274 and 276 are intercept interconnections that allow the MIOP routers to intercept data intended for the corresponding side of the tile received through the network of the die. For example, the interconnection 272 intercepts signals going to the north side of the tile 200 and signals going out from the north side of the tile 200, while the interconnection 276 intercepts signals going to the south side of the tile and signals going out from the south side of the tile.

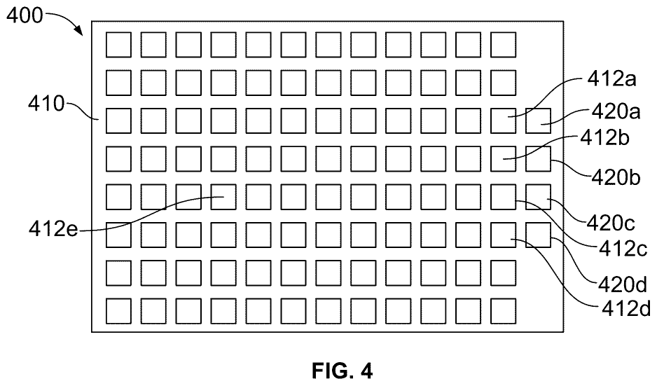

FIG. 3 is a perspective view of the cores of the array of cores 130. Each of the cores in the array of cores 130 may communicate with each other via a network 310. Areas of cores are selected for layout and configuration of selected tiles and corresponding cores that perform a program or computational function such as matrix multiplication, Fast Fourier Transform (FFT), Neural Network Convolution, and SHA Encryption. Assuming all the processing cores are functional, all the processing cores and corresponding tiles may be used for one or more configurations. In production, each processing core of the array is tested by a test host processor before the die is packaged. Defective cores and thus defective tiles are output by the test host processor in the form of a bad tile table that shows all tiles with a defective core. However, the example method allows the use of spare tiles for the array of cores that allow a die with defective tiles to function as a die with no defective tiles by routing data intended for defective tile to a spare tile, thus increasing die production yields. Typically, with an array of 128 tiles (2048 cores), provision of 4 spare tiles will increase yields of the die by up to 45% allowing previously rejected dies to be used. Practically, the area of the array of tiles on chip can be made to be near defect free using replacement tiles according to the disclosed example method. For example, a fractal array may be 48% of the die area and thus 48% of dies with defects can be recovered. Only a small percentage (3%) for defects that are in items that are in the array area cannot be recovered.

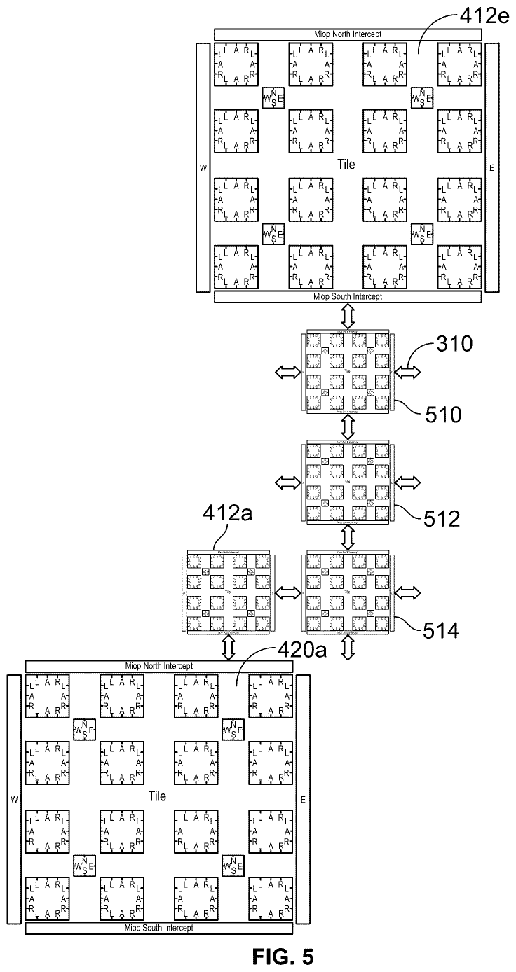

FIG. 4 shows a typical layout of tiles on a die 400 such as the die 102 in FIG. 1A. In this example, the array of cores on the die 400 is 8×16 array of tiles 410. Each of the tiles in the array of tiles 410 include 16 cores that may be similar to the tile 200 shown in FIG. 2A-2B. There may be a series of edge tiles such as tiles 412a-412d. A row of spare tiles 420a-420d is provided on the die 400 outside of the array defined by the edge tiles 412a-412d. The spare tiles 420a-420d are connected via the tile interconnections to the MIOP routers of the neighboring tiles 412a-412d on the edge of the array.

The MIOP routers in the neighboring tile to each of the spare tiles 420a-420d may be used to wrapper the L/A/R signals of the core interconnects as well as the long wire signals in/out of the spare tile on the tile edge interconnections of the spare tile and the tiles of the array. If a tile in array is defective such as an example defective tile 412e, but the interconnection network of the array is functional, then routing signals are enabled from the intercept location of the defective tile to a replacement tile 420a-420d. This would be an example type of packet data on the MIOP interconnection network that would direct packets intended for the defective tile to the replacement tile.

The MIOP routers of the defective tile 412e may be used to move the data over the network to the spare tile, such as the spare tile 420a selected to replace the defective tile. The MIOP router is ideally suited due to its wide packet width. As explained above, each of the tiles have Intercept N, S, E, W interconnections and wire router long wires such as the interconnections 270, 272, 274, and 276 in FIG. 2A. Thus, any defective tile in the array has the interconnections and wire router long wires. Each of the spare tiles 420a-420d also have the Intercept N, S, E, W interconnections and long wires shown in FIG. 2A as well. The MIOP routers of the defective tile 412e thus route the new packet type of data intended for the defective tile to the intercept edge interconnection of the spare tile that replaces the defective tile.

Intercepted data goes in both directions to enable the replacement tile to appear to be in the location of the defective tile for fractal core to fractal core traffic and wired router to wired router traffic. Thus, the interconnections such as the interconnection 270 in FIG. 2A, intercept packets intended for the defective tile and reroute them to the replacement tile. Packets from the interconnection of the replacement tile are routed to the corresponding interconnection of the defective tile for routing to their destination. The network connection points (QPLEX) of each MIOP router on the spare tile would have routable addresses for a driver to use for the link network (LSAP) and MIOP traffic to and from the spare tile. The driver swaps the new tile addresses for the defective tile addresses for purposes of routing data. Thus, a tile configuration that incorporates a defective tile such as the defective tile 412e may still operate in the array by using one of the spare tiles 420a-420d in place of the defective tile 412e.

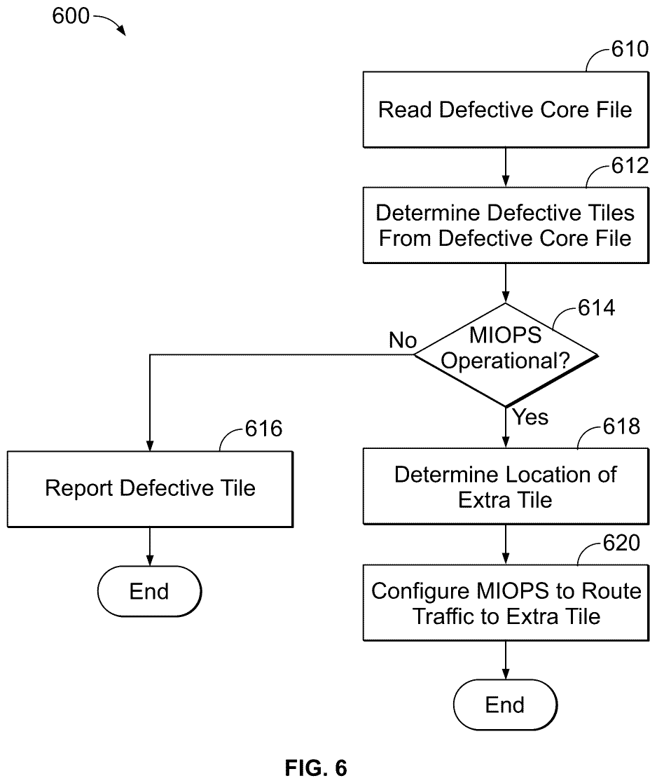

FIG. 5 shows the routing of data from the example defective tile 412e in FIG. 4 to a spare tile 420a. In this example, the routers on the defective tile 412e route data intended for the defective tile 412e to the spare tile 420a through the interconnections on each tile through the network 310 in FIG. 3. In this example, the packets are assigned new addresses corresponding to the spare tile 420a by the MIOPs on the defective tile 412e. Thus, data intended for the defective tile 412e are rerouted from the defective tile 412e through the network 310 coupled through a series of intermediate tiles 510, 512, and 514 to the edge tile 412a that is interconnected to the MIOPS of the spare tile 420a that assumes the operations of the defective tile 412e. Correspondingly, data from the spare tile 420a are routed to the correct tile through the MIOPs and interconnections of the defective tile 412e. The data from the spare tile 420a is routed to the edge tile 412a, through intermediate tiles 510, 512, and 514 to the defective tile 412e. The packets are then routed to their correct destinations via the MIOPs of the defective tile 412e.

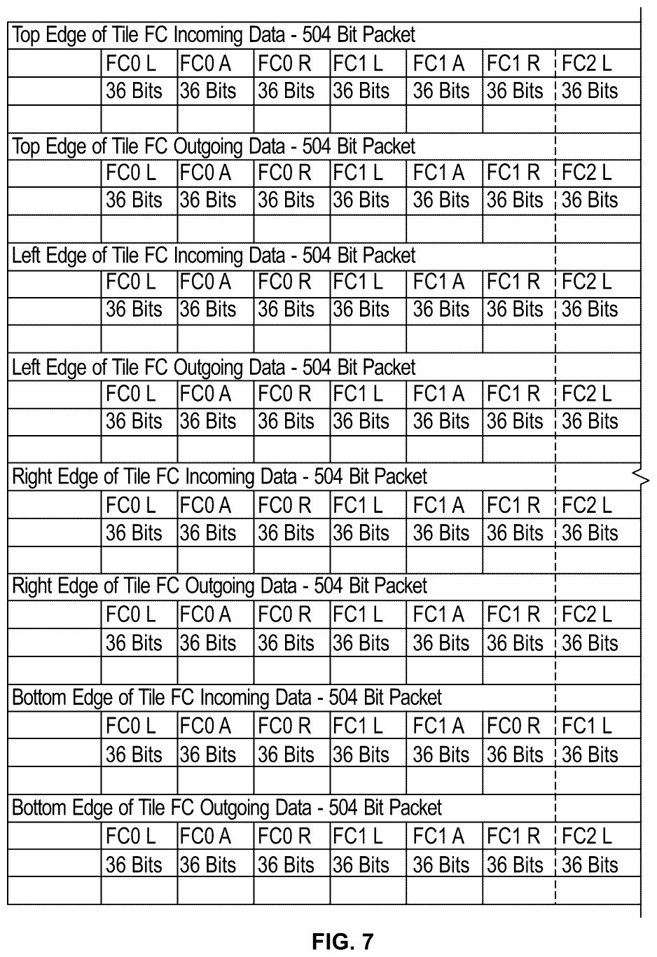

A flow diagram 600 in FIG. 6 is representative of example machine readable instructions for the process of determining a replacement tile that bypasses a defective tile in an array of tiles. The routine in FIG. 6 may be executed by a driver or library of the host. The routine may be run at configuration time of the array ahead of the topology being executed. In this example, the machine readable instructions comprise an algorithm for execution by: (a) a processor; (b) a controller; and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flowcharts may be implemented manually. Further, although the example algorithm is described with reference to the flowchart illustrated in FIG. 6, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The flow diagram 600 is a routine for bypassing and replacing a defective tile with a spare tile to enable operation of tiles on the die. The routine first reads a defective core file of all defective cores detected in the array of cores (610). The defective cores may be determined by a host processor running testing routine. The routine then determines the tiles of all defective cores (612). The algorithm then determines whether the MIOPs of the defective tiles are functional (614). If the MIOPs of the defective tile are not functional, the defective tile is reported (616) and the routine ends. If the MIOPs of defective tile are functional (614), the routine selects an unused extra tile (618). The routine then configures the MIOPs of the defective tile to route all traffic received by the defective tile to the extra tile (620). Thus, data packets received by the defective tile are provided the address of the extra tile. The extra tile assumes the role of the defective tile in any configuration that includes the defective tile.

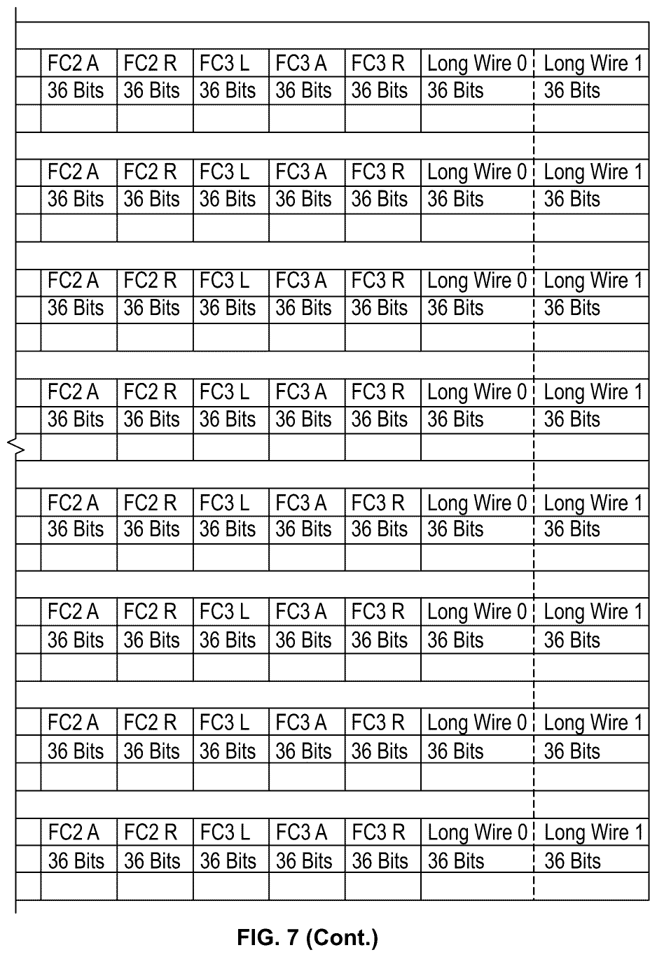

FIG. 7 shows an example summary table of addresses for a tile such as the tiles in the chip in FIG. 4. In this example the first row shows the top edge of the tile (north). The top edge receives a 504 bit packet, that is split into 36 bit sections for the interconnections of the four cores on the top edge and the two long wires. Thus, the top edge includes the L, A, R interconnections of 36 bits each for each of the four fractal cores on the top edge of the tile. The two long wires associated with the interconnection also have 36 bits. The second group of rows is the left edge of the tile with a 504 bit packet for outgoing data. The outgoing data is broken up into sections of 36 bits for each of the L, A, and R connections for each of the four fractal cores and the two long wires.

The third and fourth groups of rows show the distribution of the 504 bit packets for incoming data and outgoing data for the left edge of a tile (west). The fifth and sixth groups of rows show the distribution of the 504 bit packets for incoming data and outgoing data for the right edge of a tile (east). The seventh and eighth groups of rows show the distribution of the 504 bit packets for incoming data and outgoing data for the right edge of a tile (south).

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A method to replace a defective tile of a plurality of tiles, each tile in the plurality of tiles including a plurality of processing cores, and each of the tiles are in communication with each other through a network, the method comprising:
determining a defective tile of the plurality of tiles;
selecting a spare tile external to the plurality of tiles;
directing packets sent on the network to the defective tile to the spare tile; and
assigning a function of the defective tile to the spare tile.

2. The method of claim 1, wherein each of the tiles includes a memory input/output processor (MIOP) that routes packets to other tiles.

3. The method of claim 2, wherein packets to the defective tile are rerouted by the MIOP providing an address of the spare tile to the packets.

4. The method of claim 2, wherein each of the tiles includes a tile network coupled to each of the plurality of processing cores in each tile.

5. The method of claim 2, wherein each of the processing cores in each of the tiles includes local interconnections to each neighboring processing core and a long wire interconnection to the MIOP.

6. The method of claim 1, wherein the defective tile includes a defective processing core determined via a testing routine conducted by a host processor.

7. The method of claim 1, wherein each of the processing cores in each of the tiles are homogeneous.

8. The method of claim 1, wherein the plurality of tiles are arranged in an array fabricated on a die, and wherein the spare tile is fabricated on the die in proximity to the array.

9. The method of claim 1, wherein a packet generated by the spare tile is routed through the network to the defective tile.

10. The method of claim 1, wherein at least a subset of the plurality of tiles including the defective tile is configured to perform a computational function.

11. A computer system comprising:
a plurality of tiles, each including a plurality of processing cores and an interconnection;
a network coupled to the interconnections of each of the plurality of tiles to allow communication between the plurality of tiles; and
a spare tile including a plurality of processing cores and an interconnection coupled to the network, the spare tile located external to the plurality of tiles, wherein the spare tile is selected when a defective tile of the plurality of tiles is determined, and wherein packets sent on the network to the defective tile are directed to the spare tile; and wherein a function of the defective tile is assigned to the spare tile.

12. The computer system of claim 10, wherein each of the tiles includes a memory input/output processor (MIOP) that routes packets to other tiles.

13. The computer system of claim 12, wherein packets to the defective tile are rerouted by the MIOP providing an address of the spare tile to the packets.

14. The computer system of claim 12, wherein each of the tiles includes a tile network coupled to each of the plurality of processing cores in each tile.

15. The computer system of claim 12, wherein each of the processing cores in each of the tiles includes local interconnections to each neighboring processing core and a long wire interconnection to the MIOP.

16. The computer system of claim 11, wherein the defective tile includes a defective processing core determined via a testing routine conducted by a host processor.

17. The computer system of claim 11, wherein each of the processing cores in each of the tiles are homogeneous.

18. The computer system of claim 11, wherein the plurality of tiles are arranged in an array fabricated on a die, and wherein the spare tile is fabricated on the die in proximity to the array.

19. The computer system of claim 11, wherein a packet generated by the spare tile is routed through the network to the defective tile.

20. The computer system of claim 11, wherein at least a subset of the plurality of tiles including the defective tile is configured to perform a computational function.
